(19) United States
(12) Patent Application Publication
(10) Pub. No.: US 2012/0175563 A1
(43) Pub. Date: Jul. 12, 2012

(54) REACTIVE DILUENTS CONTAINING SILANE GROUPS

(75) Inventors: Mathias Matner, Neuss (DE); Klaus Lorenz, Dormagen (DE); Jörg Hofmann, Krefeld (DE); Michael Ludewig, Odenthal (DE); Axel Schmidt, Singapore (SG); Frank Kobelka, Koln (DE)

(73) Assignee: Bayer MaterialScience AG, Leverkusen (DE)

(21) Appl. No.: 13/395,936

(22) PCT Filed: Sep. 4, 2010
(86) PCT No.: PCT/EP2010/005443

§ 371 Date: Mar. 20, 2012

(30) Foreign Application Priority Data
Sep. 18, 2009 (DE) 10 2009 042 190.4

(51) Int. Cl. C09K 3/00

(52) U.S. Cl. 252/364; 252/380

(57) ABSTRACT

The present invention relates to reactive diluents for moisture-curing coating systems containing silane groups. The invention further relates to a method for the production of said diluents, and to the use thereof in coating agents, adhesives and sealants.

The present invention relates to reactive diluents containing silane groups and reactive plasticizers containing silane groups for moisture-curing resins, a process for the preparation thereof and their general use.

Silane-terminated polymers have been used commercially for years as raw materials for sealants and adhesives and for coating materials. For this, silicone, polyurethane or polyacrylate polymers are usually reacted with the aid of functional silanes to give the corresponding silane-terminated polymers. A disadvantage of these polymers is the comparatively high viscosity, which is caused by the polymer backbones used.

Compared with polyurethanes and polyacrylates, polyethers have a very much lower viscosity, which is to be explained by the absence of functional groups which can enter into intermolecular bonds. Silane-terminated polyethers therefore also have the advantage of a lower viscosity compared with the abovementioned silane-terminated polymers.

Polyethers containing silane groups are described, for example, in the publications DE-A 1 495 543, U.S. Pat. No. 3,971,751, JP-A 54 032 597, JP-A 58 168 623, EP-A 0 397 036 and DE 10 2004 006 531.

For coatings, sealants and adhesives based on polymers containing silane groups, however, a further lowering of the viscosity is often desirable. In many cases this is achieved by the use of solvents. The disadvantages of an ecological, toxicological and work hygiene nature which thereby arise are adequately known, so that this route can be taken only with limitations. Furthermore, in uses in which flexible coatings, sealants or adhesives are required, largely inert, low molecular weight substances of low volatility, such as, for example, mineral oils, hydrocarbon resins or dialkyl phthalates, are used. These have both a viscosity-lowering and a plasticizing effect, but also have decisive disadvantages. Depending on the particular formulation, for example, they can tend towards migration out of the cured polymer matrix, which can lead to embrittlement phenomena or can result in an undesirable contamination of the adjacent surfaces (edge zone contamination). The substances migrating out can furthermore migrate into the boundary layer between the coating and substrate and interfere with the adhesion of the coating to the substrate there, so that an unwanted detachment occurs. In particular, however, the migrating low molecular weight substances per se are frequently not completely physiologically acceptable. For example, adverse endocrine actions and reproductive toxicity have been detected with dialkyl phthalates.

The present invention was therefore based on the object of developing effective reactive diluents and reactive plasticizers for moisture-curing adhesives and sealants and coating resins containing silane groups, which impart to the base system an improved processability coupled with a good level of mechanical properties of the reacted end product and which moreover are distinguished by a significantly reduced tendency towards migration compared with standard diluents/plasticizers, such as, for example, dialkyl phthalates.

A further object of the present invention was to provide a simple process for the preparation of the effective reactive diluents/reactive plasticizers.

Effective reactive diluents/reactive plasticizers for moisture-curing coating systems containing silane groups are not known to date.

It has been found, surprisingly, that highly effective reactive diluents/reactive plasticizers for moisture-curing coating resins and sealants containing silane groups can be obtained by copolymerization of alkylene oxides and epoxides containing silane groups in the presence of monofunctional starter molecules in a simple one-stage process.

The present invention therefore provides
1. Mixtures containing compounds of the general structures I, II, III and IV

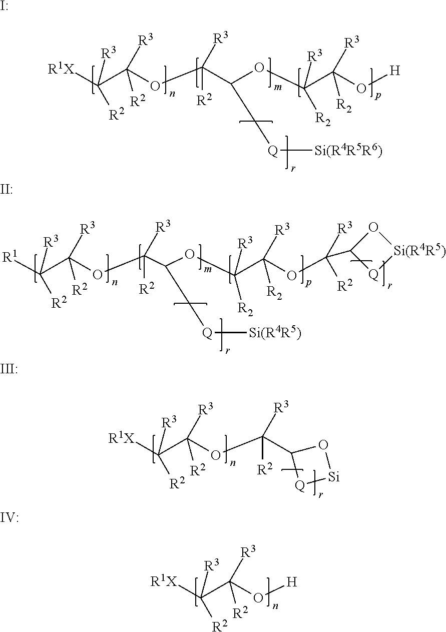

wherein
a) R¹ represents a monofunctional starter molecule radical, such as, for example, methyl, ethyl, propyl, butyl, cyclohexyl, phenyl, and X represents a hetero atom, preferably oxygen, and the hydrogen atom in R¹XH is a Zerewitinoff-active hydrogen atom,
b) R² and R³ independently of each other represent hydrogen, a C₁-C₄-alkyl radical or a phenyl radical, wherein hydrogen atoms and/or methyl groups are preferred and groups R² and R³ bonded to one C atom can be identical or different from one another,
c) [Q]ᵣ represents a chain of length r built up from oxygen and carbon atoms, wherein r is the sum of the carbon and oxygen atoms, and wherein any free valencies are satisfied by hydrogen atoms or alkyl radicals, oxygen atoms bonded to one another (peroxide structures) do not occur, silicon is always bonded to the chain [Q]ᵣ via carbon, the chain [Q]ᵣ can also be built up completely without oxygen and r can assume values of between 1 and 20,
d) R⁴, R⁵ and R⁶ represent either alkyl or O-alkyl, with the proviso that in the structures I and II at least one of the radicals R⁴, R⁵ and R⁶ on the non-cyclically bonded Si atoms denotes O-alkyl and in the structures II and III at least one of the radicals R⁴ and R⁵ of the Si atoms bonded in the cyclic end group is O-alkyl,
e) p+n in the structure I can assume values of between 5 and 300 and m can assume values of between 1 and 5, wherein the m monomer units carrying silicon groups are distributed statistically between the p+n monomer units which are free from silicon groups,
e) p+n in the structure II can assume values of between 5 and 300 and m can assume values of between 1 and 5, wherein the m monomer units with non-cyclically bonded Si atoms are distributed statistically between the p+n monomer units which are free from silicon groups,
g) n in the structures III and IV can assume values of between 5 and 300 and
h) the structures I, II and III are each present in the mixture to the extent of at least 10 wt. %.
2. A process for the preparation of the mixture according to claim 1
   wherein
   on to monofunctional starter molecules R¹XH, in which one Zerewitinoff-active hydrogen atom per starter molecule bonded to X, with the meaning of sulfur or oxygen, preferably oxygen,
   alkylene oxides with the following general structures

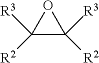

wherein R² and R³ independently of each other represent hydrogen, a C₁-C₄-alkyl radical or a phenyl radical, wherein hydrogen atoms and/or methyl groups are preferred and groups R² and R³ bonded to one C atom can be identical or different from one another,
together with epoxides containing silane groups, which have the following general structures

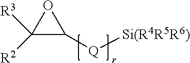

wherein R² and R³ independently of each other represent hydrogen, a C₁-C₄-alkyl radical or a phenyl radical, wherein hydrogen atoms and/or methyl groups are preferred and groups R² and R³ bonded to one C atom can be identical or different from one another,
   [Q]ᵣ represents a chain of length r built up from oxygen and carbon atoms, where r=the sum of the carbon and oxygen atoms, and wherein any free valencies are satisfied by hydrogen atoms or alkyl radicals, oxygen atoms bonded to one another (peroxide structures) do not occur, silicon is always bonded to the chain [Q]ᵣ via carbon, the chain [Q]ᵣ can also be built up completely without oxygen and r can assume values of between 1 and 20,
   R⁴, R⁵ and R⁶ are either alkyl or O-alkyl, with the proviso that at least one of the radicals R⁴, R⁵ and R⁶ denotes O-alkyl,
      are polymerized, using one or more catalysts.
3. A process according to claim 2, wherein compounds which catalyse the atactic polymerization of racemic mixtures of 1-alkyl epoxides are employed as catalysts.
4. A process according to claim 3, wherein a double metal cyanide compound which catalyses the atactic polymerization of racemic mixtures of 1-alkyl epoxides is employed as the catalyst.
5. A process according to one of claims 2 to 4, wherein the reaction temperature is in the range of from 60° C. to 170° C.
6. A process according to one of claims 2 to 5, wherein the reaction temperature is in the range of from 130° C. to 170° C.
7. The use of the mixtures according to the invention as reactive diluents or reactive plasticizers in coating compositions, adhesives or sealants.

Catalysts which are preferably used are so-called double metal cyanide catalysts (DMC catalysts), of which it has been known for a long time that they are suitable for the commercial preparation of polyether polyols by ring-opening polymerization of alkylene oxides in the presence of suitable starter compounds, and that the racemic propylene oxide preferably employed in this context as the alkylene oxide is polymerized atactically. As a consequence of this, the polypropylene glycols prepared by DMC catalysis are amorphous, liquid products having a relatively low viscosity.

The DMC catalysts which are suitable for the process according to the invention are known in principle and are described in detail in the prior art. Highly active DMC catalysts which are described e.g. in U.S. Pat. No. 5,470,813, EP-A 0 700 949, EP-A 0 743 093, EP-A 0 761 708, WO1997/040086, WO1998/016310 and WO2000/047649 are preferably employed. The highly active DMC catalysts described in EP-A 0 700 949 which, in addition to a double metal cyanide compound (e.g. zinc hexacyanocobaltate(III)) and an organic complexing ligand (e.g. tert-butanol), also contain a polyether having a number-average molecular weight of greater than 500 g/mol are a typical example.

It is also possible for basic catalysts, such as, for example, alkali metal hydroxides, alkali metal hydrides, alkali metal carboxylates, alkaline earth metal hydroxides or amines, to be used, since these likewise atactically polymerize racemic propylene oxide. A disadvantage of these catalysts is their basicity, which can impede the curing of coating resins containing silane groups under the action of moisture in cases where the curing is to be acid-catalysed. The separating off of traces of basic catalyst by working up steps is therefore in general necessary, for example by ion exchange processes.

Compounds with molecular weights of from 32 to 10,000 and one Zerewitinoff-active hydrogen atom per molecule are preferably used as starter molecules. There may be mentioned by way of example: methanol, ethanol, butanol, butyl diglycol, 2-ethylhexanol, oleyl alcohol, stearyl alcohol, phenol, naphthol and mercaptoethanol.

Hydrogen bonded to N, O or S is called Zerewitinoff-active hydrogen (sometimes also only “active hydrogen”) if it delivers methane by reaction with methylmagnesium iodide by a method discovered by Zerewitinoff. Typical examples of compounds with Zerewitinoff-active hydrogen are compounds which contain carboxyl, hydroxyl, amino, imino or thiol groups as functional groups.

Alkylene oxides which can be employed are, for example, ethylene oxide, propylene oxide, butylene oxide, styrene oxide or isobutylene oxide. Ethylene oxide, propylene oxide or butylene oxide are particularly preferably used. The epoxides can be metered individually as individual substances, in succession or in a mixture. If various epoxides are metered in succession, polyether chains with block structures are obtained. With mixed metering, mixed block structures result.

Compounds which can be used as compounds which contain at least one epoxy group and at least one silicon atom carrying hydrolysable radicals are, for example, 3-(glycidoxypropyl)trimethoxysilane 3-(glycidoxypropyl)triethoxysilane, 3-(glycidoxypropyl)methyldimethoxysilane or 3-(glycidoxypropyl)methyldiethoxysilane or the corresponding α-compounds 3-(glycidoxymethyl)trimethoxysilane, 3-(glycidoxymethyl)triethoxysilane, 3-(glycidoxymethyl)methyldimethoxysilane, or 3-(glycidoxymethyl)methyldiethoxysilane. The compounds containing at least one epoxy group and at least one silicon atom carrying hydrolysable radicals can be used individually or as mixtures. 3-(Glycidoxypropyl)trimethoxysilane and/or 3-(glycidoxypropyl)triethoxysilane are preferred. These compounds are called epoxysilane in the following.

In detail, the process according to the invention can be carried out by the following process variants A), B), C):
A) The starter compound containing one Zerewitinoff-active hydrogen atom per molecules, called “starter” in the following, is initially introduced into the reactor. If the DMC compounds preferably to be employed are used as catalysts, the OH number of the starter should not exceed values of 600 mg of KOH/g. In order to render starters with a higher OH number also accessible to such a process, prepolymers with a correspondingly reduced OH number can first be prepared from these, for example by means of basic catalysis by alkylene oxide addition, and, after careful separating off of traces of basic catalyst, can be employed in the process. Mixtures of 2 and more starters can also be used.

The alkylene oxide addition catalyst, preferably a DMC compound, is now added to the starters. If basic catalysts, such as, for example, alkali metal hydroxides, alkali metal hydrides, alkali metal carboxylates, alkaline earth metal hydroxides or amines, are used, it is advisable to free the reaction mixture from water by evacuation and/or stripping with inert gas. If DMC catalysts are employed, a stripping step at the reaction temperature, but at least at 60° C., should also be carried out before metering of the epoxide is started. The amounts of catalyst to be employed vary between 10 and 1,000 ppm in the case of the DMC catalysts preferably to be used. Preferably, amounts of DMC catalyst of between 10 and 300 ppm are employed. Basic catalysts are in general employed in higher concentrations of from 100 to 10,000 ppm. These catalyst concentrations stated are based on the total weight of end product in the particular batch. The reaction temperatures vary between 50° C. and 170° C., preferably between 70° C. to 160° C., particularly preferably between 85° C. and 160° C. and very particularly preferably between 110° C. and 160° C. The reaction temperatures can also be varied in the stated ranges during the epoxide metering phase.

The alkylene oxide(s) are now polymerized on to the starter(s) together with the epoxysilane(s). For this, the alkylene oxide(s) and the epoxysilane(s) are metered into the reactor such that the safety pressure limits of the system are not exceeded. In the case of the DMC catalysts which are preferably to be employed, it may be necessary to activate the catalyst by metering a small amount of epoxide (2 to 10 wt. %, based on the weight present in the reactor at the start). The activation of a DMC catalyst in general manifests itself by an accelerated drop in pressure following an initial increase in pressure. In the main metering phase, the epoxides can be metered in a mixture with one another or also in a mixture with the epoxysilanes, but it is also possible to meter the epoxides successively and/or also separately from the epoxysilanes with respect to time. Depending on the metering strategy, polyether chains with monomer units distributed statistically over the contour length or polyether chains with block structures are obtained. Preferably, at the end of the metering phase pure epoxide or an epoxide mixture without epoxysilane is metered, in order to ensure complete reaction of the epoxysilane. The ratio of starters containing Zerewitinoff-active hydrogen atoms to epoxides and epoxysilanes can be varied within wide limits. Possible ranges are from 0.03 to 5 mol, preferably 0.03 to 1 mol and particularly preferably from 0.03 to 0.25 mol of Zerewitinoff-active hydrogen atoms per kg of product. The ratio of epoxysilane to Zerewitinoff-active hydrogen atoms can also be varied widely. Typical ratios are in ranges of from 0.5 to 5 mol of epoxysilane per mol of Zerewitinoff-active hydrogen atoms, and ratios of between 0.5 to 2 mol of epoxysilane per mol of Zerewitinoff-active hydrogen atoms are preferred.

After the end of the epoxide metering phase or of the metering phase of epoxide and epoxysilane, an after-reaction phase conventionally follows, in which the epoxy groups which have not yet reacted can react.
B) If starters with OH numbers higher than 600 mg of KOH/g are to be employed in DMC-catalysed processes, in addition to the abovementioned prelengthening of the starter, the so-called continuous starter metering process, which is disclosed in WO 97/29146, is available as a process variant. In this, the starter is not initially introduced into the reactor, but is fed continuously to the reactor during the reaction alongside the alkylene oxide(s) and the epoxysilane(s). In this process, prepolymers which have been obtained by epoxide addition on to starter compounds containing one Zerewitinoff-active hydrogen atom per molecule can be initially introduced as the starting medium for the reaction, the use of small amounts of the product to be prepared itself being particularly advantageous. Before the start of the metering, amounts of DMC catalyst as described above are added to the precursor/product to be initially introduced as the starting medium, and should have a mathematical OH number of from 5 to 600 mg of KOH/g. The amount of precursor/product advantageously to be used as the starting medium depends on the particular reactor and stirrer geometry and the design of the heating and cooling device. It is to be chosen such that the reaction mixture can be easily stirred, and furthermore the heat of reaction should be easy to remove, or the contents of the reactor should be easy to heat. In this process variant, the metering of the starter is conventionally ended before the end of the metering of epoxide and epoxysilane, in order to be able to add epoxide or epoxysilane on to all the starter compounds in a sufficient amount and therefore to obtain uniform products. After the end of the phase of metering in the starter, the composition of the epoxide/epoxysilane mixture can of course also be changed, as a result of which polyether chains with block structures are also accessible by this process variant.
C) The reactive diluents/reactive plasticizers according to the invention can also be prepared in a completely continuous manner by a process such as is described in WO1998/003571 for the preparation of polyethers. In this, in addition to epoxide, epoxysilane and starter (mixture), the DMC catalyst is also fed continuously to the reactor under alkoxylation conditions and the product is removed continuously after a preselectable average reactor dwell time. Polyether chains with block structures can be obtained in this process variant only by using reactor cascades.

The reactive diluents/reactive plasticizers according to the invention for moisture-curing resins containing silane groups can be used in a varied and advantageous manner in coating, sealing and adhesive systems. For this, the reactive diluents/reactive plasticizers according to the invention are formulated by known processes with moisture-curing resins containing silane groups and with the fillers, pigments, plasticizers, desiccants, additives, light stabilizers, antioxidants, thixotropy agents, catalysts, adhesion promoters and optionally further auxiliary substances and additives conventional in this context. Suitable resins which can be employed are polymers based on polysiloxanes, polyethers, polyurethanes, polyacrylates or other polymers which contain moisture-reactive silane groups. Suitable fillers which can be employed are precipitated or ground chalks, metal oxides, sulfates, silicates, hydroxides, carbonates and bicarbonates. Further fillers are e.g. reinforcing and non-reinforcing fillers, such as carbon black, precipitated silicas, pyrogenic silicas, quartz flour or diverse fibres. The fillers can optionally be modified on the surface. Precipitated or ground chalks and pyrogenic silicas can particularly preferably be employed. Mixtures of fillers can also be employed.

Suitable plasticizers which may be mentioned by way of example are phthalic acid esters, adipic acid esters, alkylsulfonic acid esters of phenol or phosphoric acid esters. Long-chain hydrocarbons, polyethers and plant oils can also be used as plasticizers.

Thixotropy agents which may be mentioned by way of example are pyrogenic silicas, polyamides, hydrogenated castor oil secondary products or also polyvinyl chloride.

Suitable catalysts which can be employed for the curing are all organometallic compounds and aminic catalysts which are known to promote silane polycondensation. Particularly suitable organometallic compounds are, in particular, compounds of tin and of titanium. Preferred tin compounds are, for example: dibutyltin diacetate, dibutyltin dilaurate, dioctyltin maleate and tin carboxylates, such as, for example, tin(II) octoate or dibutyltin bis-acetoacetonate. The tin catalysts mentioned can optionally be used in combination with aminic catalysts, such as aminosilanes or 1,4-diazabicyclo[2.2.2]octane. Preferred titanium compounds are, for example, alkyl titanates, such as diisobutyl-bisacetoacetic acid ethyl ester titanate. Aminic catalysts which are suitable for sole use are, in particular, those which have a particularly high base strength, such as amines having an amidine structure. Preferred aminic catalysts are therefore, for example, 1,8-diazabicyclo[5.4.0]undec-7-ene or 1,5-diazabicyclo[4.3.0]-non-5-ene. Protic acids, such as, for example, p-toluenesulfonic acid, dodecylbenzenesulfonic acid or other Brønstedt acids which are compatible with the particular formulation can furthermore also be employed. A combination of various catalysts is also possible.

Desiccants which may be mentioned are, in particular, alkoxysilyl compounds, such as vinyltrimethoxysilane, methyltrimethoxysilane, i-butyltrimethoxysilane, hexadecyltrimethoxysilane or other low molecular weight silane compounds. Highly reactive isocyanates, such as, for example, 4-toluenesulfonyl isocyanate, can also be employed as desiccants.

Adhesion promoters which can be employed are the known silanes, such as, for example, aminosilanes, such as aminopropyltrimethoxysilane, aminopropylmethyl-dimethoxysilane, aminopropylmethyldiethoxysilane, aminopropylmethyldiethoxysilane, N-butyl-aminopropyltrimethoxysilane, N-ethyl-aminopropyltrimethoxysilane and also N-aminoethyl-3-aminopropyltrimethoxy- and/or N-aminoethyl-3-aminopropylmethyl-dimethoxysilane, chloropropyltrimethoxysilane, epoxysilanes, such as those mentioned above, and/or mercaptosilanes, such as mercaptopropyltrimethoxysilane, mercaptopropylmethyldimethoxysilane, mercaptopropyltriethoxysilane or mercaptopropylmethyldiethoxysilane.

The coating, sealing and adhesive systems can furthermore be formulated with various additives. These are in some cases co-ordinated specifically to the particular resins used and are known to the person skilled in the art.

Coating, sealing and adhesive systems based on moisture-curing resins containing silane groups can achieve a relatively low viscosity appropriate for the application by the use of the reactive diluents/reactive plasticizers according to the invention and/or have a relatively low hardness and/or relatively high extensibility in the cured state. Coating, sealing and adhesive systems which have the advantages of lower volume shrinkage, lower migration and lower ecotoxic potential compared with the conventional solvents and plasticizers can be formulated by the use of the reactive diluents/reactive plasticizers according to the invention. As a result, further advantages may arise, such as an improved adhesion, a reduced edge zone contamination or better over-lacquering properties.

### EXAMPLES

### Raw Materials Used

IRGANOX® 1076: Octadecyl 3-(3,5-di-tert-butyl-4-hydroxyphenyl)propionate
   (Bayer Materialscience AG, Leverkusen, DE)
Butyl diglycol: Diethylene glycol monobutyl ether

### Example 1

0.023 g of an 85 wt. % strength phosphoric acid was added to 242.9 g of butyl diglycol in a 10 l laboratory autoclave and the mixture was stirred at room temperature for 20 min. Thereafter, 1.229 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.12 bar, by an accelerated drop in pressure. After metering in a further 300 g of propylene oxide (metering rate: 872.6 g/h), the reaction temperature was lowered to 85° C. and the co-metering of 416.8 g of 3-(glycidoxypropyl)triethoxysilane was started. These were metered in together with the remaining propylene oxide (5,030.2 g) such that towards the end a further 885 g of propylene oxide were metered in without parallel metering of 3-(glycidoxypropyl)triethoxysilane. After an after-reaction time of 2 h, the contents of the reactor were heated thoroughly at 85° C. in vacuo (10 mbar) for 30 min, after which 3,013 g of IRGANOX® 1076 were added. The product had a viscosity of 640 mPas at 25° C.

### Example 2

0.029 g of an 85 wt. % strength phosphoric acid was added to 242.8 g of butyl diglycol in a 10 l laboratory autoclave and the mixture was stirred at room temperature for 20 min. Thereafter, 1.216 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 0.89 bar, by an accelerated drop in pressure. After metering in a further 300 g of propylene oxide (metering rate: 853.6 g/h), the reaction temperature was lowered to 85° C. and the co-metering of 353.8 g of 3-(glycidoxypropyl)trimethoxysilane was started. These were metered in together with the remaining propylene oxide (5,093.2 g) such that towards the end a further 870 g of propylene oxide were metered in without parallel metering of 3-(glycidoxypropyl)trimethoxysilane. After an after-reaction time of 2 h, the contents of the reactor were heated thoroughly at 85° C. in vacuo (10 mbar) for 30 min, after which 3,001 g of IRGANOX® 1076 were added. The product had a viscosity of 520 mPas at 25° C.

### Example 3

0.011 g of an 85 wt. % strength phosphoric acid was added to 121.4 g of butyl diglycol in a 10 l laboratory autoclave and the mixture was stirred at room temperature for 20 min. Thereafter, 1.200 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 0.91 bar, by an accelerated drop in pressure. After metering in a further 300 g of propylene oxide (metering rate: 776.9 g/h), the reaction temperature was lowered to 85° C. and the co-metering of 417.0 g of 3-(glycidoxypropyl)triethoxysilane was started. These were metered in together with the remaining propylene oxide (5,151.6 g) such that towards the end a further 882 g of propylene oxide were metered in without parallel metering of 3-(glycidoxypropyl)triethoxysilane. After an after-reaction time of 2 h, the contents of the reactor were heated thoroughly at 85° C. in vacuo (10 mbar) for 30 min, after which 3,014 g of IRGANOX® 1076 were added. The product had a viscosity of 2,960 mPas at 25° C.

### Example 4

0.013 g of an 85 wt. % strength phosphoric acid was added to 242.8 g of butyl diglycol in a 10 l laboratory autoclave and the mixture was stirred at room temperature for 20 min. Thereafter, 0.313 g of DMC catalyst was added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 0.98 bar, by an accelerated drop in pressure. After metering in a further 300 g of propylene oxide (metering rate: 872.6 g/h), the reaction temperature was lowered to 85° C. and the co-metering of 416.8 g of 3-(glycidoxypropyl)triethoxysilane was started. These were metered in together with the remaining propylene oxide (5,030.2 g) such that towards the end a further 848 g of propylene oxide were metered in without parallel metering of 3-(glycidoxypropyl)triethoxysilane. After an after-reaction time of 4.62 h, the contents of the reactor were heated thoroughly at 85° C. in vacuo (10 mbar) for 30 min, after which 3,053 g of IRGANOX® 1076 were added. The product had a viscosity of 1,150 mPas at 25° C.

### Example 5

0.026 g of an 85 wt. % strength phosphoric acid was added to 242.8 g of butyl diglycol in a 10 l laboratory autoclave and the mixture was stirred at room temperature for 20 min. Thereafter, 1.202 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.12 bar, by an accelerated drop in pressure. Towards the end of the metering of a further 2,660.1 g of propylene oxide (metering rate: 1,064 g/h), the reaction temperature was lowered to 85° C., the propylene oxide metering rate was reduced to 899 g/h and the co-metering of 416.8 g of 3-(glycidoxypropyl)triethoxysilane was started. These were metered in together with the remaining propylene oxide (2,670.1 g) such that towards the end a further 858 g of propylene oxide were metered in without parallel metering of 3-(glycidoxypropyl)triethoxysilane. After an after-reaction time of 2 h, the contents of the reactor were heated thoroughly at 85° C. in vacuo (10 mbar) for 30 min, after which 3,105 g of IRGANOX® 1076 were added. The product had a viscosity of 675 mPas at 25° C.

### Example 6

0.028 g of an 85 wt. % strength phosphoric acid was added to 242.9 g of butyl diglycol in a 10 l laboratory autoclave and the mixture was stirred at room temperature for 20 min. Thereafter, 1.237 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of a 1:1 mixture of propylene oxide and ethylene oxide, which could be seen, after an increase in pressure from 50 mbar to 1.21 bar, by an accelerated drop in pressure. After metering in a further 300 g of the 1:1 mixture of propylene oxide and ethylene oxide (metering rate: 871.4 g/h), the reaction temperature was lowered to 85° C. and the co-metering of 416.8 g of 3-(glycidoxypropyl)triethoxysilane was started. These were metered in together with the remaining propylene oxide/ethylene oxide mixture (5,022.9 g) such that towards the end a further 947 g of the propylene oxide/ethylene oxide mixture were metered in without parallel metering of 3-(glycidoxypropyl)triethoxysilane. After an after-reaction time of 1.33 h, the contents of the reactor were heated thoroughly at 85° C. in vacuo (10 mbar) for 30 min, after which 3,013 g of IRGANOX® 1076 were added. The product had a viscosity of 700 mPas at 25° C.

### Example 7

0.011 g of an 85 wt. % strength phosphoric acid was added to 121.7 g of butyl diglycol in a 10 l laboratory autoclave and the mixture was stirred at room temperature for 20 min. Thereafter, 1.245 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.21 bar, by an accelerated drop in pressure. After metering in a further 300 g of propylene oxide (metering rate: 907.2 g/h), the reaction temperature was lowered to 85° C. and the co-metering of 208.4 g of 3-(glycidoxypropyl)triethoxysilane was started. These were metered in together with the remaining propylene oxide (5,360.1 g) such that towards the end a further 924 g of propylene oxide were metered in without parallel metering of 3-(glycidoxypropyl)triethoxysilane. After an after-reaction time of 1 h, the contents of the reactor were heated thoroughly at 85° C. in vacuo (10 mbar) for 30 min, after which 3,001 g of IRGANOX® 1076 were added. The product had a viscosity of 2,190 mPas at 25° C.

### Example 8

0.014 g of an 85 wt. % strength phosphoric acid was added to 121.5 g of butyl diglycol in a 10 l laboratory autoclave and the mixture was stirred at room temperature for 20 min. Thereafter, 1.205 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.10 bar, by an accelerated drop in pressure. After metering in a further 300 g of propylene oxide (metering rate: 898.3 g/h), the reaction temperature was lowered to 85° C. and the co-metering of 417.0 g of 3-(glycidoxypropyl)trimethoxysilane was started. These were metered in together with the remaining propylene oxide (5,214.6 g) such that towards the end a further 916 g of propylene oxide were metered in without parallel metering of 3-(glycidoxypropyl)trimethoxysilane. After an after-reaction time of 2 h, the contents of the reactor were heated thoroughly at 85° C. in vacuo (10 mbar) for 30 min, after which 3,037 g of IRGANOX® 1076 were added. The product had a viscosity of 1,400 mPas at 25° C.

### Example 9

0.014 g of an 85 wt. % strength phosphoric acid was added to 121.4 g of butyl diglycol in a 10 l laboratory autoclave and the mixture was stirred at room temperature for 20 min. Thereafter, 1.220 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.10 bar, by an accelerated drop in pressure. After metering in a further 200 g of propylene oxide (metering rate: 905.7 g/h), the co-metering of 417.0 g of 3-(glycidoxypropyl)trimethoxysilane was started. These were metered in together with the remaining propylene oxide (5,314.5 g) at 130° C. such that towards the end a further 897 g of propylene oxide were metered in without parallel metering of 3-(glycidoxypropyl)trimethoxysilane. After an after-reaction time of 2 h, the contents of the reactor were heated thoroughly at 130° C. in vacuo (10 mbar) for 30 min, after which 3,009 g of IRGANOX® 1076 were added. The product had a viscosity of 740 mPas at 25° C.

### Example 10

0.011 g of an 85 wt. % strength phosphoric acid was added to 121.6 g of butyl diglycol in a 10 l laboratory autoclave and the mixture was stirred at room temperature for 20 min. Thereafter, 1.237 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.10 bar, by an accelerated drop in pressure. After metering in a further 300 g of propylene oxide (metering rate: 937.8 g/h), the reaction temperature was lowered to 85° C. and the co-metering of 176.9 g of 3-(glycidoxypropyl)trimethoxysilane was started. These were metered in together with the remaining propylene oxide (5,391.8 g) such that towards the end a further 927 g of propylene oxide were metered in without parallel metering of 3-(glycidoxypropyl)trimethoxysilane. After an after-reaction time of 1 h, the contents of the reactor were heated thoroughly at 85° C. in vacuo (10 mbar) for 30 min, after which 3,021 g of IRGANOX® 1076 were added. The product had a viscosity of 1,490 mPas at 25° C.

### Example 11

0.013 g of an 85 wt. % strength phosphoric acid was added to 121.6 g of butyl diglycol in a 10 l laboratory autoclave and the mixture was stirred at room temperature for 20 min. Thereafter, 1.225 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 1.32 bar, by an accelerated drop in pressure. After metering in a further 300 g of propylene oxide (metering rate: 934.9 g/h), the reaction temperature was lowered to 85° C. and the co-metering of 101.1 g of 3-(glycidoxypropyl)trimethoxysilane was started. These were metered in together with the remaining propylene oxide (5,467.6 g) such that towards the end a further 980 g of propylene oxide were metered in without parallel metering of 3-(glycidoxypropyl)trimethoxysilane. After an after-reaction time of 1 h, the contents of the reactor were heated thoroughly at 85° C. in vacuo (10 mbar) for 30 min, after which 3,027 g of IRGANOX® 1076 were added. The product had a viscosity of 1,970 mPas at 25° C.

### Example 12

0.015 g of an 85 wt. % strength phosphoric acid was added to 122.0 g of butyl diglycol in a 10 l laboratory autoclave and the mixture was stirred at room temperature for 20 min. Thereafter, 1.274 g of DMC catalyst were added and the contents of the reactor were stripped at 80° C. with stirring at 450 rpm for 30 min, while passing in 50 ml of nitrogen per min. The mixture was heated up to 130° C., while stirring (450 rpm), and the DMC catalyst was activated by addition of 10 g of propylene oxide, which could be seen, after an increase in pressure from 50 mbar to 0.88 bar, by an accelerated drop in pressure. After metering in a further 300 g of propylene oxide (metering rate: 963.8 g/h), the reaction temperature was lowered to 85° C. and the co-metering of 354.0 g of 3-(glycidoxypropyl)trimethoxysilane was started. These were metered in together with the remaining propylene oxide (5,106.6 g) such that towards the end a further 981 g of propylene oxide were metered in without parallel metering of 3-(glycidoxypropyl)trimethoxysilane. After an after-reaction time of 15 min, the mixture was heated up again to 130° C. and 108.0 g of butylene oxide were metered in over a period of 33 min. After an after-reaction time of 1 h at 130° C., the contents of the reactor were heated thoroughly at 130° C. in vacuo (10 mbar) for 30 min, after which 3,060 g of IRGANOX® 1076 were added. The product had a viscosity of 930 mPas at 25° C.

### Example 13

150.0 g of butyl diglycol propoxylate with an OH number of 37.3 mg of KOH/g were introduced into a 2 l laboratory autoclave. Thereafter, 0.28 g of DMC catalyst was added and the contents of the reactor were stripped at 80° C. with stirring at 800 rpm for 30 min, while passing in nitrogen under 100 mbar abs. The mixture was heated up to 130° C., while stirring (1,200 rpm), and the DMC catalyst was activated by addition of 10 g of propylene oxide. After metering in a further 50 g of propylene oxide (metering rate: 306 g/h), the co-metering of 23.6 g of 3-(glycidoxypropyl)trimethoxysilane was started.

These were metered in together with the remaining propylene oxide (1,166.4 g) such that towards the end a further 308 g of propylene oxide were metered in without parallel metering of 3-(glycidoxypropyl)trimethoxysilane. After an after-reaction time of 2 h at 130° C., the contents of the reactor were heated thoroughly at 130° C. in vacuo (15 mbar) for 60 min, after which 0.7 g of IRGANOX® 1076 was added. The product had a viscosity of 8,688 mPas at 25° C.

### Detection of the Tendency Towards Migration

As a comparison example, 50 g of Desmoseal® S XP 2636 (silane-terminated polyurethane, Bayer MaterialScience AG) were mixed with 50 g of Jayflex® DNP (plasticizer, ExxonMobil GmbH) and 0.5 g of Lupragen® N 700 (catalyst, BASF SE) in a dissolver. The example according to the invention was prepared in a corresponding manner by mixing Desmoseal® S XP 2636 with the reactive diluent from Example 1 and Lupragen® N 700. The mixtures were then each poured out on to a Teflon sheet and cured under normal conditions (23° C./50% rel. hum.) for 14 days.

Films of the two examples were transferred into a Soxhlet apparatus and extracted with n-hexane under reflux for 8 hours. The extraction residue was dried at 100° C. in a drying cabinet and then weighed. The following table shows the results:

| | |
|---|---|
| Film with reactive | Film with DINP |
| diluent | as a comparison |
| from Example 1 | example |

| | | | | |
|---|---|---|---|---|
| Sample weight | 9.9250 | g | 10.4942 | g |
| Extraction residue | 2.6793 | g | 4.9768 | g |
| Extraction residue | 27.0 | wt. % | 47.4 | wt. % |

The advantage of the reactive diluent/plasticizer according to the invention clearly manifests itself here. While the plasticizer of the comparison example can be extracted almost completely, only approximately half of the reactive diluent/plasticizer can be extracted from the example according to the invention.

### Formulation of a Joint Sealing Composition

The following components were processed to a ready-to-use sealant in a commercially available vacuum planetary dissolver with a wall scraper and cooling jacket:

### Stage 1

| | | |
|---|---|---|
| 18.8 | parts by wt. | Desmoseal ® S XP 2636 (Bayer MaterialScience |
| | | AG) |
| 23.2 | parts by wt. | reactive diluent according to the invention or |
| | | plasticizer (comparison examples) |
| 51.3 | parts by wt. | Socal ® U1S2 (precipitated chalk, Solvay GmbH) |
| 3.1 | parts by wt. | Tronox ® 435 (pigment, Tronox Pigments GmbH) |
| 0.5 | part by wt. | Tinuvin ® 292 (UV absorber, Ciba AG) |
| 0.5 | part by wt. | Tinuvin ® 1130 (HALS, Ciba AG) |
| 0.3 | part by wt. | Irganox ® 1135 (antioxidant, Ciba AG) |
| 1.4 | parts by wt. | Dynasylan ® VTMO (desiccant, Evonik AG) |
| 0.1 | part by wt. | Lupragen ® N 700 (BASF SE) |

Stage 1 of the mixture was dispersed under a pressure of 200 mbar for a total of 15 minutes, of these 10 minutes at n=3,000 min⁻¹ and a further 5 minutes at n=1,000 min⁻¹, while cooling and with a static vacuum. The incorporation of

### Stage 2

| | | |
|---|---|---|
| 0.9 | part by wt. | Dynasylan ® 1189 (adhesion promoter, Evonik AG) |

was then carried out over a period of 10 minutes at n=1,000 min⁻¹, while cooling. This procedure was carried out for 5 minutes under a static vacuum and a further 5 minutes under a dynamic vacuum.

The product was transferred into a commercially available polyethylene cartridge and stored at room temperature.

After storage for one day, films of approx. 2 mm thick were produced from the sealing compositions.

The following mechanical properties were determined after curing of the films for fourteen days at 24° C. and 50% relative atmospheric humidity:

| | | | Example according | Example according | Example according |
|---|---|---|---|---|---|
| | Comparison | Comparison | to the invention | to the invention | to the invention |
| | example | example | Reactive diluent | Reactive diluent | Reactive diluent |
| | DINP | Mesamoll ® | from Example 1 | from Example 4 | from Example 7 |
| Tensile strength | 3.5 | 3.6 | 3.7 | 3.5 | 3.6 |
| (DIN 53504), [N/mm²] | | | | | |
| 100% modulus (DIN | 0.2 | 0.3 | 0.2 | 0.3 | 0.3 |
| 52455/1), [N/mm²] | | | | | |
| Elongation at break | 932 | 927 | 1053 | 904 | 915 |
| (DIN 53504), [%] | | | | | |
| Shore A hardness | 19 | 24 | 19 | 22 | 23 |
| (DIN 53505) | | | | | |
| Tackiness 1/3/7/14 d* | 1/1/1/1 | 1/1/1/1 | 1/1/1/1 | 2/1/1/1 | 2/1/1/1 |

*Scale of 1-5; 1 = tack-free, 3 = slight surface tackiness, particles of dirt adhere, 5 = very tacky material, scarcely to be separated from adhering material.

It is found here that the reactive diluents/plasticizers according to the invention show comparable or even superior mechanical properties to the conventional unreactive plasticizers.

### Formulation of an Adhesive for Floor Coverings

The following components were processed to a ready-to-use adhesive in a commercially available vacuum planetary dissolver with a wall scraper and cooling jacket:

### Stage 1

| | | |
|---|---|---|
| 26.4 | parts by wt. | Desmoseal ® S XP 2636 (Bayer MaterialScience |
| | | AG) |
| 13.1 | parts by wt. | reactive diluent according to the invention or |
| | | plasticizer (comparison examples) |
| 55.1 | parts by wt. | Omyalite ® 95T (precipitated chalk, Omya AG) |
| 0.3 | part by wt | Bayferrox ® 415 (pigment, Lanxess AG) |
| 0.4 | part by wt. | Irganox ® 1135 (Ciba AG) |
| 0.8 | part by wt. | Cab-O-Sil ® TS 720 (pyrogenic silica, Cabot Corp.) |
| 2.3 | parts by wt. | Dynasylan ® VTMO (Evonik AG) |
| 0.1 | part by wt. | Lupragen ® N 700 (BASF SE) |

Stage 1 of the mixture was dispersed under a pressure of 200 mbar for a total of 15 minutes, of these 10 minutes at n=3,000 min⁻¹ and a further 5 minutes at n=1,000 min⁻¹, while cooling and with a static vacuum. The incorporation of

### Stage 2

| | | |
|---|---|---|
| 1.5 | parts by wt. | Dynasylan ® 1146 (adhesion promoter, Evonik AG) |

was the carried out over a period of 10 minutes at n=1,000 min⁻¹, while cooling. This procedure was carried out for 5 minutes under a static vacuum and a further 5 minutes under a dynamic vacuum.

The product was transferred into a commercially available polyethylene cartridge and stored at room temperature.

After storage for one day, both films of approx. 2 mm thick and beech/beech test specimens, for determination of the longitudinal shear strength, were produced from the adhesives.

The following mechanical properties were determined after curing of the samples at 24° C. and 50% relative atmospheric humidity for seven days (longitudinal shear strength) or fourteen days (films):

| | | Example according |
|---|---|---|
| | Comparison | to the invention |
| | example | Reactive diluent |
| | Mesamoll ® | from Example 1 |
| Tensile strength (DIN 53504), | 3.0 | 3.2 |
| [N/mm²] | | |
| Elongation at break (DIN | 189 | 218 |
| 53504), [%] | | |
| Shore A hardness (DIN 53505) | 57 | 57 |
| Longitudinal shear strength | 3.3 | 3.1 |
| 7 d (DIN EN 14293), [N/mm²] | | |
| Tackiness 1/3/7/14 d* | 1/1/1/1 | 1/1/1/1 |
| Sprayability [s/50 g] | 34 | 35 |

*Scale of 1-5; 1 = tack-free, 3 = slight surface tackiness, particles of dirt adhere, 5 = very tacky material, scarcely to be separated from adhering material.

The sprayability was determined as the time required to force 50 g of adhesive, with the aid of a pneumatic cartridge gun, through a cartridge tip of 2.4 mm diameter under a pressure of 2.0 bar.

The measurement values show the good viscosity-reducing effect of the reactive diluents/plasticizers according to the invention.

### Formulation of an Elastic Adhesive

The following components were processed to a ready-to-use adhesive in a commercially available vacuum planetary dissolver with a wall scraper and cooling jacket:

### Stage 1

| | | |
|---|---|---|
| 39.6 | parts by wt. | Desmoseal ® S XP 2458 (silane-terminated |
| | | polyurethane, Bayer MaterialScience AG) |
| 8.6 | parts by wt. | reactive diluent according to the invention or |
| | | plasticizer (comparison examples) |
| 46.0 | parts by wt. | Socal ® U1S2 (Solvay GmbH) |
| 0.1 | part by wt. | black paste (Lanxess AG) |
| 0.5 | part by wt. | Irganox ® 1135 (Ciba AG) |
| 1.6 | parts by wt. | Cab-O-Sil ® TS 720 (Cabot Corp.) |
| 2.4 | parts by wt. | Dynasylan ® VTMO (Evonik AG) |
| 0.1 | part by wt. | Lupragen ® N 700 (BASF SE) |

Stage 1 of the mixture was dispersed under a pressure of 200 mbar for a total of 15 minutes, of these 10 minutes at n=3,000 min⁻¹ and a further 5 minutes at n=1,000 min⁻¹, while cooling and with a static vacuum. The incorporation of

### Stage 2

| | | |
|---|---|---|
| 1.1 | parts by wt. | Dynasylan ® 1146 (Evonik AG) |

was then carried out over a period of 10 minutes at n=1,000 min⁻¹, while cooling. This procedure was carried out for 5 minutes under a static vacuum and a further 5 minutes under a dynamic vacuum.

The product was transferred into a commercially available polyethylene cartridge and stored at room temperature.

After storage for one day, films of approx. 2 mm thick were produced from the sealing compositions.

The following mechanical properties were determined after curing of the films for fourteen days at 24° C. and 50% relative atmospheric humidity:

| | | Example according |
|---|---|---|
| | Comparison | to the invention |
| | example | Reactive diluent |
| | Mesamoll ® | from Example 1 |
| Tensile strength (DIN 53504), | 3.0 | 3.1 |
| [N/mm²] | | |
| Elongation at break (DIN 53504), | 181 | 218 |
| [%] | | |
| 100% modulus (DIN 52455/1), | 2.3 | 2.2 |
| [N/mm²] | | |
| Shore A hardness (DIN 53505) | 63 | 62 |
| Tackiness 1/3/7/14 d* | 1/1/1/1 | 1/1/1/1 |

*Scale of 1-5; 1 = tack-free, 3 = slight surface tackiness, particles of dirt adhere, 5 = very tacky material, scarcely to be separated from adhering material.

1.-7. (canceled)

8. A mixture comprising compounds of the structures I, II, III and IV 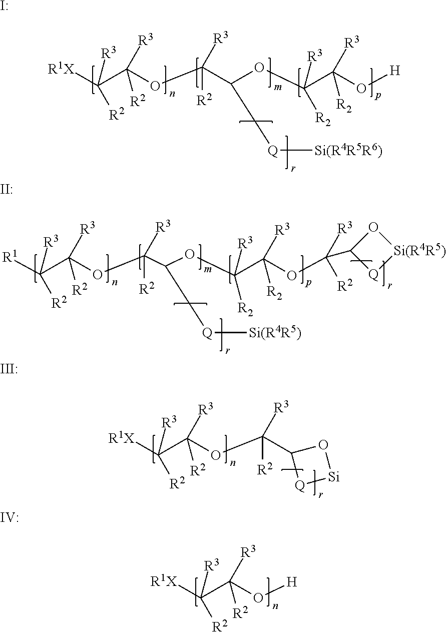
wherein
a) R¹ represents a monofunctional starter molecule radical, and X represents a hetero atom, and the hydrogen atom in R¹XH is a Zerewitinoff-active hydrogen atom,
b) R² and R³ independently of each other represent hydrogen, a C₁-C₄-alkyl radical or a phenyl radical, wherein groups R² and R³ bonded to one C atom can be identical or different from one another,
c) [Q]ᵣ represents a chain of length r built up from oxygen and carbon atoms, where r=the sum of the carbon and oxygen atoms, and wherein any free valencies are satisfied by hydrogen atoms or alkyl radicals, oxygen atoms bonded to one another (peroxide structures) do not occur, silicon is always bonded to the chain [Q]ᵣ via carbon, the chain [Q]ᵣ can also be built up completely without oxygen and r can assume values of between 1 and 20,
d) R⁴, R⁵ and R⁶ represent either alkyl or O-alkyl, with the proviso that in the structures I and II at least one of the radicals R⁴, R⁵ and R⁶ on the non-cyclically bonded Si atoms is an O-alkyl and in the structures II and III at least one of the radicals R⁴ and R⁵ on the Si atoms bonded in the cyclic end group is an O-alkyl,
e) p+n in the structure I can assume values of between 5 and 300 and m can assume values of between 1 and 5, wherein the m monomer units carrying silicon groups are distributed statistically between the p+n monomer units which are free from silicon groups,
f) p+n in the structure II can assume values of between 5 and 300 and m can assume values of between 1 and 5, wherein the m monomer units with non-cyclically bonded Si atoms are distributed statistically between the p+n monomer units which are free from silicon groups,
g) n in the structures III and IV can assume values of between 5 and 300
and
h) the structures I, II and III are each present in the mixture to the extent of at least 10 wt. %.

9. The mixture according to claim 8, wherein R1 represents methyl, ethyl, propyl, butyl, cyclohexyl, or phenyl.

10. The mixture according to claim 8, wherein X represents oxygen.

11. The mixture according to claim 8, wherein R² and R³ independently of each other represent hydrogen and/or a methyl group.

12. A process for the preparation of the mixture according to claim 8, in which
on to a monofunctional starter molecule R¹XH, wherein X represents a hetero atom, and H is one Zerewitinoff-active hydrogen atom per starter molecule bonded via X, and R¹ represents any desired radical which does not interfere with the alkylene oxide addition reaction,
an alkylene oxide with the following structure 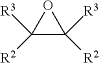
wherein R² and R³ independently of each other represent hydrogen, a C₁-C₄-alkyl radical or a phenyl radical, wherein groups R² and R³ bonded to one C atom can be identical or different from one another,
together with an epoxide containing silane groups, which have the following structure 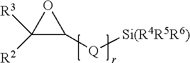
wherein R² and R³ independently of each other represent hydrogen, a C₁-C₄-alkyl radical or a phenyl radical, wherein groups R² and R³ bonded to one C atom can be identical or different from one another,
[Q]ᵣ represents a chain of length r built up from oxygen and carbon atoms, where r=the sum of the carbon and oxygen atoms, and wherein any free valencies are satisfied by hydrogen atoms or alkyl radicals, oxygen atoms bonded to one another (peroxide structures) do not occur, silicon is always bonded to the chain [Q]ᵣ via carbon, the chain [Q]ᵣ can also be built up completely without oxygen and r can assume values of between 1 and 20, R⁴, R⁵ and R⁶ independently of each other denote either alkyl or O-alkyl, but with the proviso that at least one of the radicals R⁴, R⁵ and R⁶ is O-alkyl,
are polymerized, using one or more catalysts.

13. The process according to claim 12, wherein the one or more catalysts comprise compounds which catalyse the atactic polymerization of racemic mixtures of 1-alkyl epoxides.

14. The process according to claim 13, wherein the one or more catalysts comprise a double metal cyanide compound which catalyses the atactic polymerization of racemic mixtures of 1-alkyl epoxides.

15. The process according to claim 12, wherein the reaction temperature is in the range of from 60° C. to 170° C.

16. The process according to claim 12, wherein the reaction temperature is in the range of from 130° C. to 170° C.

17. A reactive diluent or reactive plasticizer in coating compositions, adhesives or sealants comprising the mixture according to claim 8.

18. The process according to claim 12, wherein R1 represents methyl, ethyl, propyl, butyl, cyclohexyl, or phenyl.

19. The process according to claim 12, wherein X represents oxygen.

20. The process according to claim 12, wherein R² and R³ independently of each other represent hydrogen and/or a methyl group.
